(19) United States
(12) Patent Application Publication
(10) Pub. No.: US 2010/0199731 A1
(43) Pub. Date: Aug. 12, 2010

(54) PIN TUMBLER CYLINDER LOCK

(75) Inventor: Anatoly Kofman, Holon (IL)

Correspondence Address: DEBORAH A. GADOR, P.O. BOX 4133, GANEL TIKVA, 55900, IL

(73) Assignee: J BEER METAL INDUSTRIES LTD, HOLON (IL)

(21) Appl. No.: 12/679,325

(22) PCT Filed: Sep. 23, 2008
(86) PCT No.: PCT/IL08/01272

§ 371 Date: Mar. 22, 2010

(30) Foreign Application Priority Data
Sep. 24, 2007 (IL) 186219

(51) Int. Cl. E05B 27/06; E05B 17/00; E05B 9/04; B23P 17/04

(52) U.S. Cl. 70/358; 70/431; 70/449; 29/428

(57) ABSTRACT

The present invention relates to a pin tumbler cylinder lock having a cylinder casing and a plug selectively rotatable in the casing, and a plurality of driver pins and associated tumbler pins rotatable about their longitudinal axes. The cylinder lock includes a plurality of parallel circumferential tracks formed in the cylinder casing. Each of the tumbler pins is adapted and configured to seat in the plug and includes a track engaging element arranged to selectively engage one of said tracks. The tumbler pins are arranged to align both vertically and horizontally with matching depressions in a symmetrical key, in order to permit the turning of the plug in the cylinder casing when the key is turned.

### FIELD OF THE INVENTION

The present invention relates to pin tumbler cylinder locks in general and, in particular, to a cylinder lock with twisting tumblers.

### BACKGROUND OF THE INVENTION

Pin tumbler cylinder locks are well known in the art. These locks typically include a cylinder casing and a plug rotatable in the casing. A plurality of tumbler pins typically sit in the plug and a plurality of driver pins are spring biased in registration therewith in the cylinder casing. When an appropriate key is inserted in the lock, the tumbler pins are urged into height alignment inside the plug and the driver pins are urged against the springs into the casing, such that the shear line is not blocked and the plug can be turned inside the cylinder casing to lock or unlock the lock.

There are known pin tumbler locks having rotating tumblers, such as that shown in U.S. Pat. No. Re. 30,198 assigned to Mechanical Development Co., Inc. This cylinder lock includes a side bar or fence adapted to be cammed out of engagement with the cylinder shell to permit the key plug to be rotated. This lock is operated by a one sided, toothed key.

### SUMMARY OF THE INVENTION

The present invention relates to a pin tumbler cylinder lock having a cylinder casing and a plug selectively rotatable in the casing, and a plurality of driver pins and associated tumbler pins rotatable about their longitudinal axes. The cylinder lock includes a plurality of parallel circumferential tracks formed in the cylinder casing. Each of the tumbler pins is adapted and configured to seat in the plug and includes a track engaging element arranged to selectively engage one of said tracks.

According to one embodiment of the invention, the tracks are circumferential channels formed in internal surface of cylinder casing and the tumbler pins have a ridge adapted and configured to move in the channels when the plug is rotated in the casing.

According to an alternative embodiment of the invention, the tracks are circumferential ridges formed in an internal surface of the cylinder casing, and the tumbler pins have a groove adapted and configured to engage the ridges when the plug is rotated in the casing.

There is also provided, according to the invention, a key for a pin tumbler cylinder lock having a plurality of tumbler pins, the key including a shank having a plurality of depressions in two opposing side surfaces, the depressions being formed at an angle to one another, the depressions being adapted and configured, when inserted into the cylinder lock, to engage the tumbler pins and rotate the tumbler pins about their longitudinal axes.

There is further provided, according to the invention, a method for forming a pin tumbler cylinder lock having a cylinder casing and a plug selectively rotatable in the casing, and a plurality of driver pins and associated tumbler pins rotatable about their longitudinal axes, the method including forming a plurality of parallel circumferential tracks in a cylinder casing of a cylinder lock, providing a plurality of tumbler pins, each including a track engaging element, and disposing the tumbler pins in the plug whereby each of the track engaging elements selectively engages one of the tracks.

A key for a cylinder lock, the key including a shank defining at least one shank bore, and at least one insert protruding from the shank, the insert being disposed in the bore. Preferably, the insert is movable in the bore.

### BRIEF DESCRIPTION OF THE DRAWINGS

The present invention will be further understood and appreciated from the following detailed description taken in conjunction with the drawings in which:

FIG. 1 is a partially cut-away exploded view of a cylinder lock and key, constructed and operative in accordance with one embodiment of the present invention;

FIG. 2 is a perspective view of a set of tumblers according to one embodiment of the invention;

FIGS. 3a and 3b are top detail views of a portion of the cylinder lock of FIG. 1;

FIG. 4a is a sectional view of a cylinder lock according to the invention in a locked orientation;

FIGS. 4b and 4c are sectional views of the cylinder lock of FIG. 4a with a key inserted therein;

FIGS. 5a and 5b are top views of a plug for the cylinder lock according to one embodiment of the invention;

FIG. 6 is a perspective view of a pair of tumbler pins according to an alternative embodiment of the invention;

FIG. 7a is a perspective view of a key for a lock according to one embodiment of the invention; and

FIG. 7b is a perspective view of a key for a lock according to an alternative embodiment of the invention.

FIGS. 8a, 8b and 8c are perspective, exploded and side views, respectively, of a two sided symmetrical key according to one embodiment of the invention;

FIGS. 8d is a side view of a key insert according to one embodiment of the invention.

FIG. 9a is a perspective view of a plug for a cylinder lock according to a further embodiment of the invention; and

FIGS. 9b and 9c are perspective and plan views of a symmetrical key for use with the plug of FIG. 9a.

FIGS. 10a and 10b are perspective and exploded views, respectively, of a two sided symmetrical key according to another embodiment of the invention;

### DETAILED DESCRIPTION OF THE INVENTION

The present invention relates to a cylinder lock for reducing thieves' ability to pick the lock. This is accomplished by providing a cylinder lock including a plurality of rotating tumbler pins in a casing, and a plug and casing arrangement which retains the tumbler pins in the proper alignment during locking and unlocking. The tumblers are arranged to align both vertically and horizontally with matching depressions in a symmetrical key, in order to permit the turning of the plug in the cylinder casing when the key is turned.

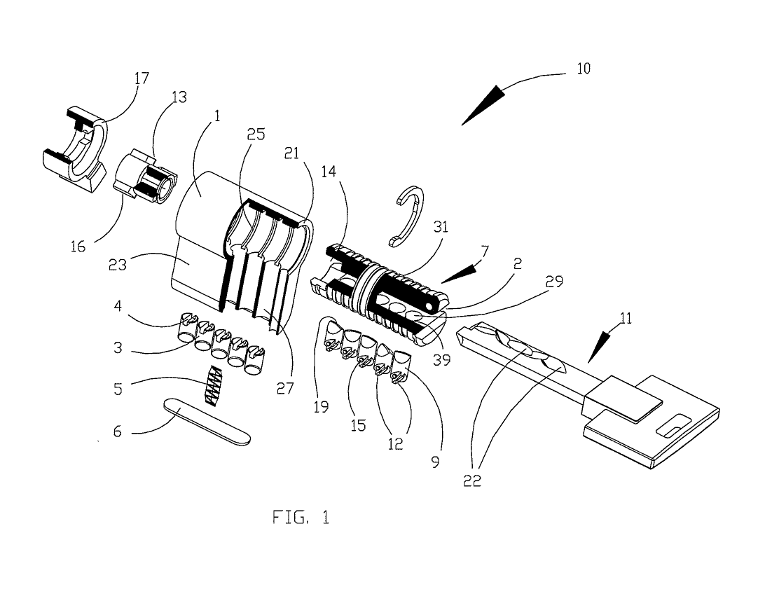

Referring now to FIG. 1, there is shown an exploded illustration of a cylinder lock 10, with associated key 11, constructed and operative according to one embodiment of the present invention. The cylinder lock 10 includes a cylinder casing 1 having a tubular upper portion 21 and a lower base portion 23. A substantially cylindrical plug 7 is arranged to seat rotatably within tubular upper portion 21 of the casing 1 for locking and unlocking lock 10. Tubular upper portion 21 defines a plurality of parallel circumferential channels 25, here illustrated as grooves. Lower base portion 23 includes a plurality of substantially cylindrical bores 27. A plurality of reciprocating and rotating tumbler pins 9 and complementary driver pins 3 are disposed for reciprocating movement within bores 27. According to a preferred embodiment of the invention, mating engagement surfaces are provided between tumbler pins 9 and driver pins 3, causing them to act like a single elongate pin when aligned one above the other.

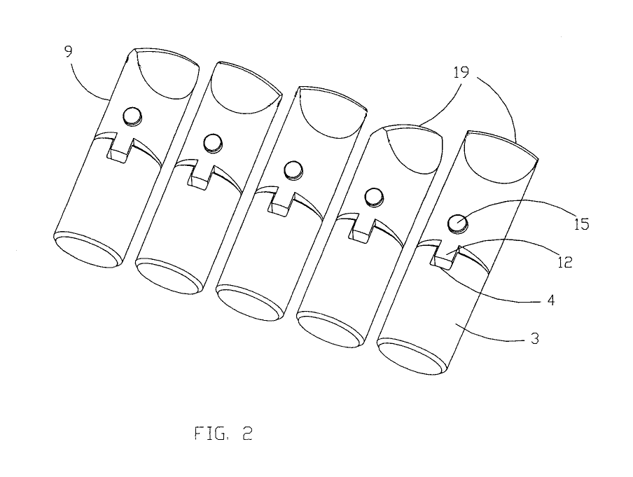

Each tumbler pin 9 has a tapered top end 19 which is positioned at an angle to a longitudinal axis extending through the cylinder lock, as known. A bottom end of each tumbler pin 9 includes a track engagement element 12, in this embodiment, a ridge. A protruding tooth 15 is provided on the side of each tumbler pin 9 to limit rotation of the tumbler pin in the casing, as described below. Each driver pin 3 includes a complementary track 4 adapted to receive ridge 12 of the associated tumbler pin 9, when the tumbler pins and driver pins are aligned within bores 27 in the casing. A schematic perspective view of a set of tumblers according to one embodiment of the invention is shown in FIG. 2.

Plug 7 defines a plurality of upstanding ridges 31, adapted and configured for rotation in channels 25 in the casing and through tracks 4 in the driver pins. Plug 7 further includes openings 2 and 2′ to a keyway allowing key entry from both sides of the lock. Plug 7 also includes a plurality of pin receiving apertures 29. Each pin receiving aperture 29 is substantially circular with an arcuate extension 39 around a pre-defined portion of its circumference.

A bolt activating element 17 is pivotally disposed in casing 1. An actuator 13 for selectively engaging bolt activating element 17 is inserted into upper portion 21 of casing 1 and fitted to recesses 14 on the plug, as known. When the proper key 11 is inserted all the way into lock 10, the distal end of key 11 pushes actuator 13 into bolt activating element 17. This couples plug 7 to bolt activating element 17 and permits the plug to rotate the bolt activating element when the key in the lock is rotated. It will be appreciated that this arrangement provides a further preventive measure against picking of the lock.

When assembled, driver pins 3 are spring biased in cylindrical bores 27 in lower base portion 23, by means of a plurality of springs 5 which are held in place by bottom member 6. Each tumbler pin 9 is seated in a pin-receiving aperture 29 in plug 7, with protruding tooth 15 in extension 39, and plug 7 is inserted in upper portion 21 of casing 1 so that ridges 31 slidingly engage circumferential grooves 25. In this orientation, tumbler pins 9 are disposed directly above driver pins 3 and engage driver pins 3 via ridges 12 seating in grooves 4.

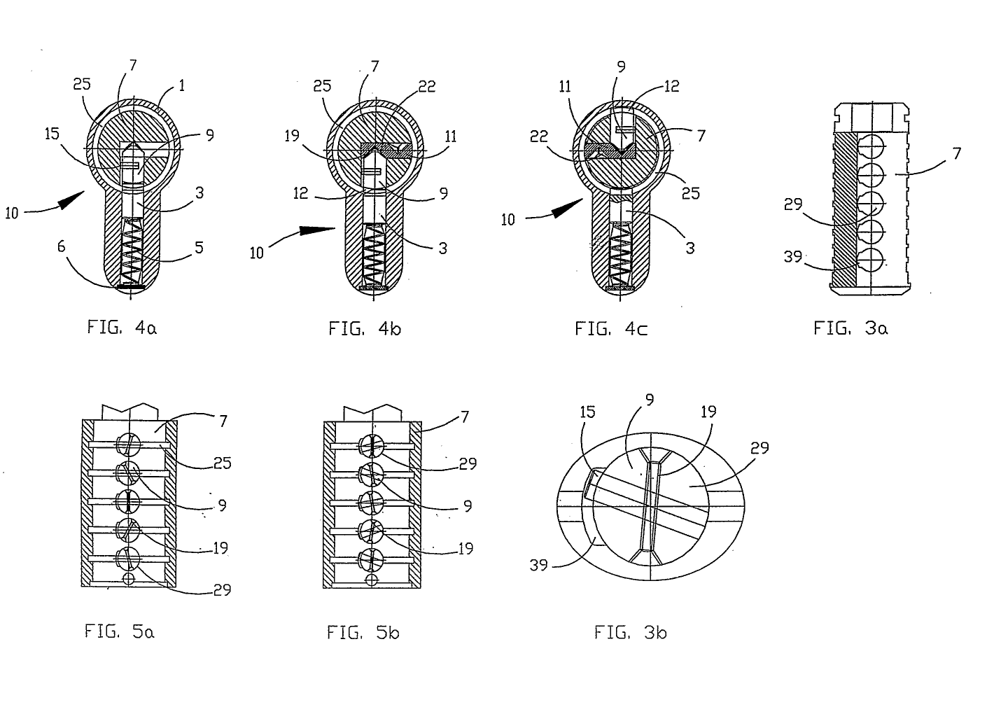

Referring to FIG. 3a and FIG. 3b, there is shown a top view of a plug 7 with apertures 29 having tumbler pins 9 seated therein and a detailed view of one such aperture, respectively. As can be seen most clearly in FIG. 3b, pin 9 is free to rotate in aperture 29, limited only by the dimensions of extension 39 and of tooth 15. It will be appreciated that tooth 15 can pivot freely in extension 39 of aperture 29, but its rotation is limited to the length of the arc of extension 39. The tapered top ends 19 of pins 9 protrude through apertures 29 into the keyway defined along the center of plug 7.

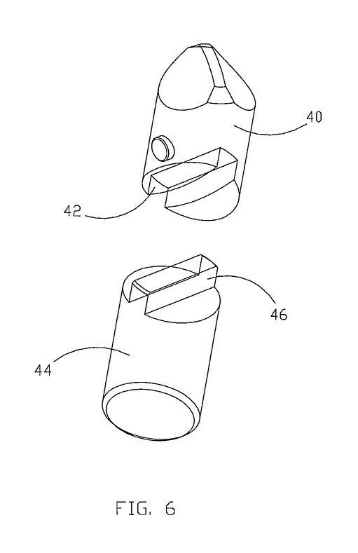

Referring to FIG. 4a to FIG. 4c, there are shown cross sectional views of cylinder lock 10 with associated key 11 in various locking states. In FIG. 4a, cylinder lock 10 is in its locked state. As in conventional pin tumbler locks, when no key is inserted in the lock, springs 5 (held in place by bottom member 6) urge driver pins 3 which engage tumbler pins 9 towards plug 7. In this way, driver pins 3 block the shear line of the lock and prevent rotation of the plug 7 relative to the casing 1. Furthermore, each of pins 9 was rotated about its longitudinal axis (limited by tooth 15 in extension 39, as described above) when the key was pulled out, as shown in FIG. 5a, an illustration of the inside of plug 7 with pin tumblers 9 in bores 27.

When key 11 is inserted into the keyway of cylinder lock 10 (through opening 2 or 2′), as shown in FIG. 4b, angled depressions 22 in key 11 cause pins 9 to rotate about their longitudinal axes according to the angle of tapered tips 19, as shown in FIG. 5b. When the appropriate key is inserted, all tumbler pins 9 rotate to seat in complementary depressions 22 in the key, until the driver pins are aligned in height near the shear line 24 of the lock. In FIG. 4b, when a key is inserted, tumbler pins 9 together with driver pins 3 are pushed down towards bores 27, until only bottom ridge 12 extends from plug 7 and the driver pins 3 are seated completely in bores 27 in casing 1. In this orientation, the driver pins no longer block the shear line, thereby permitting rotation of plug 7 relative to the casing.

FIG. 4c illustrates cylinder lock 10 where Plug 7 has been turned 180° relative to the casing, and tumbler pins 9 have disengaged from driver pins 3. Key 11 may now be removed without locking the cylindrical lock. It is a particular feature of the present invention, that plug 7 includes tracks engaging complementary tracks in driver pins 3, while the tubular upper portion 21 of casing 1 includes internal tracks 25 which engage complementary tracks on the tumbler pins 9. In this way, both driver pins and tumbler pins are retained substantially in alignment and are prevented from rotating freely within the casing when the lock is unlocked.

It will be appreciated that when it is desired to open the lock, it will be necessary to re-align each tumbler pin 9 with its associated driver pin 3. In the illustrated embodiment, in order to retain the pins in the proper orientation to permit ridge 12 to engage groove 4, ridges 12 rotate within internal channels 25 in the casing, while external ridges 31 on plug 7 engage grooves 4.

According to an alternative embodiment of the invention, shown in FIG. 6, tumbler pins 40 may define a groove 42, while driver pins 44 define a complementary protruding ridge 46. In this way, the groove 42 of a driver pin 40 will engage the ridge 46 of the associated driver pin 44 when the pins are aligned in bores 27 of the casing, retaining the action of a single pin. In this case, the tracks (not shown) in the upper portion of the casing will include inwardly protruding ridges to engage grooves 42 and the tracks in the plug will include a plurality of parallel grooves (not shown) for engaging ridges 46 when the plug is rotated from the locked orientation.

It will appreciated that it is not necessary to provide mating surfaces between the tumbler pins and the driver pins. It is only necessary for the tumbler pins to have track engaging elements for engaging tracks in the casing. The driver pins can have a substantially flat upper surface, in which case, the plug does not require any external tracks.

The arrangement of angled tumbler pins engaging⁻circumferential tracks in the interior of the cylinder casing permits the use of a symmetrical, two-sided key, unlike the prior art.

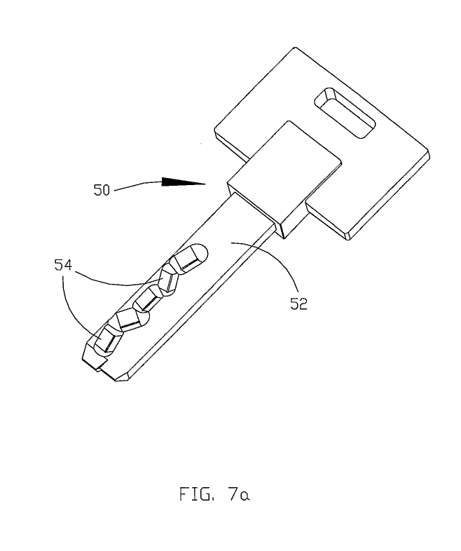

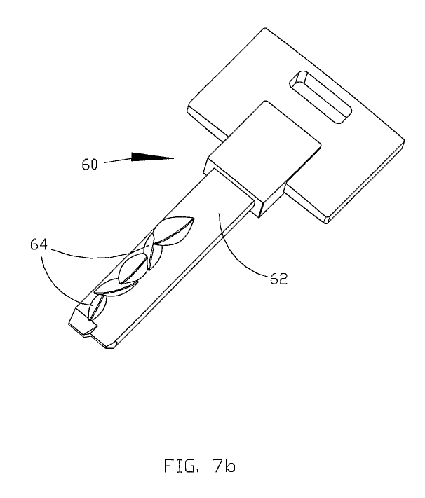

FIG. 7a is a perspective view of a key 50 for a lock according to one embodiment of the invention. Key 50 is a symmetric, flat, metal key including a shank 52 having depressions 54 defined in the surface on both sides thereof for engaging the angled tips of the radially displaceable tumbler pins in the lock casing. Depressions 54 are ground at an angle to one another and to the longitudinal axis of the shank. In this embodiment, the depressions are formed by a pointed bit grinding a linear depression 54. It will be appreciated that insertion of key 50 into a complementary pin tumbler lock as described above will cause the depressions 54 to engage the angled tips of the tumbler pins, causing them to rotate about their longitudinal axes.

A perspective view of a key 60 for a lock according to an alternative embodiment of the invention is shown in FIG. 7b. Key 60 is substantially similar to key 50, but the depressions 64 in its shank 62 are formed by a disc-shaped bit and are rounded.

It will be appreciated that the tumbler pins in the cylinder lock of the present invention may be of different heights, as well as being arranged at different angles. In this case, the depressions in the complementary key will be of different depths, so as to cause the driver pins to align below the shear line and permit rotation of the plug.

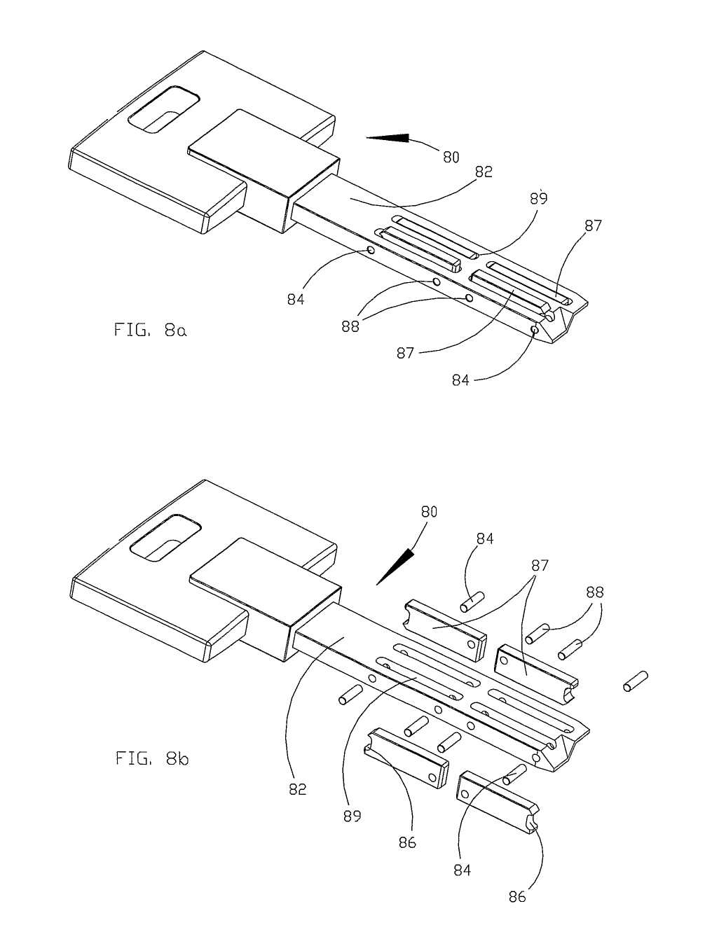

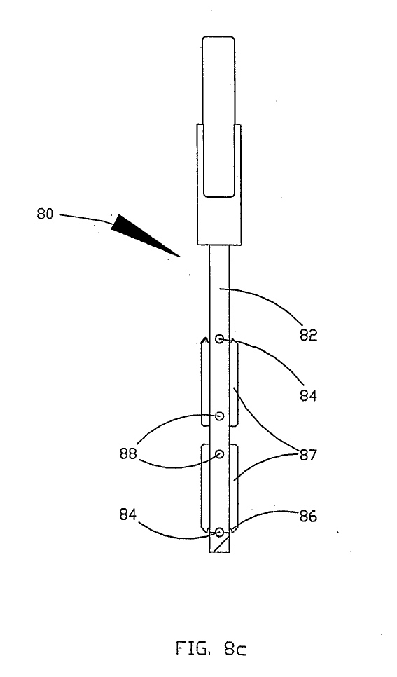

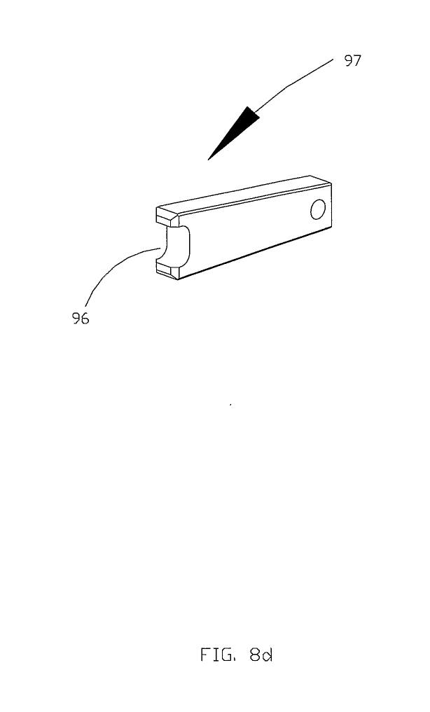

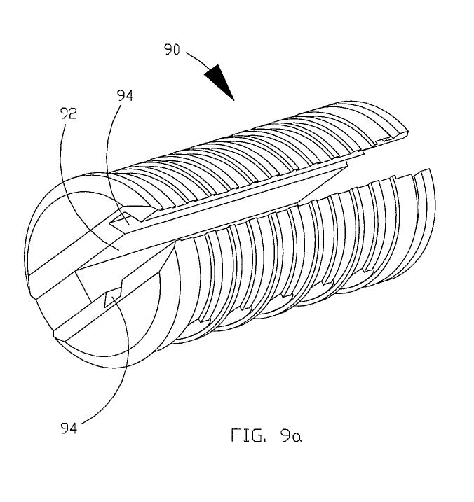

There is further provided, in accordance with the present invention, a two sided, symmetrical key for a cylinder lock having one or more protruding inserts, preferably movable, which provide increased security against picking. A blank 80 for such a key is illustrated in respective perspective, exploded and side views in FIGS. 8a, 8b and 8c. In this embodiment, blank 80 includes a shank 82 having four inserts 87, reciprocatingly mounted in shank bores 89. Alternatively, any desired number of inserts can be provided, with the minimum being one that protrudes on both sides of the key. In this embodiment, inserts 87 are illustrated as substantially rectangular inserts. However, it will be appreciated that the inserts can be, alternatively, of any desired shape.

While inserts 87 can be fixed in bores 89 at a desired protrusion height, it is preferred that inserts 87 be capable of pivotal or other reciprocating movement into and out of bores 89. Thus, at least one portion of insert 87 is coupled to shank 82, as by pivot pins 88. In the embodiment illustrated in FIGS. 8a to 8c, each of inserts 87 defines a pin-engaging recess 86 at one end thereof and is pivotally coupled in bore 89 about a pin 88 at its other end. A stop pin 84 is mounted in each bore 89 for limiting the motion of inserts 87. Pin-engaging recess 86 is wider than pin 84, thereby permitting insert 87 to pivot in and out of bore 89 until one side of recess 86 engages stop pin 84. As inserts 87 pivot into shank 82, the insertion of key 80 into a complementary cylinder lock (not shown) is facilitated.

FIG. 8d shows an alternative embodiment of the invention. According to this embodiment insert 97 is trapeze shaped which its narrow base is coupled to shank 82 by pivot pin 88 and its wide base defines a pin-engaging recess 96. Pin-engaging recess 96 is wider than pin 84 thereby permitting insert 97 to pivot in and out of bore 89. According to this embodiment pin-engaging recess 96 is wider than pin-engaging recess 86 of FIG. 8c and thereby permitting insert 97 to pivot in and out of bore 89 with more freedom, which further facilitate the insertion of key 80 into the cylinder lock.

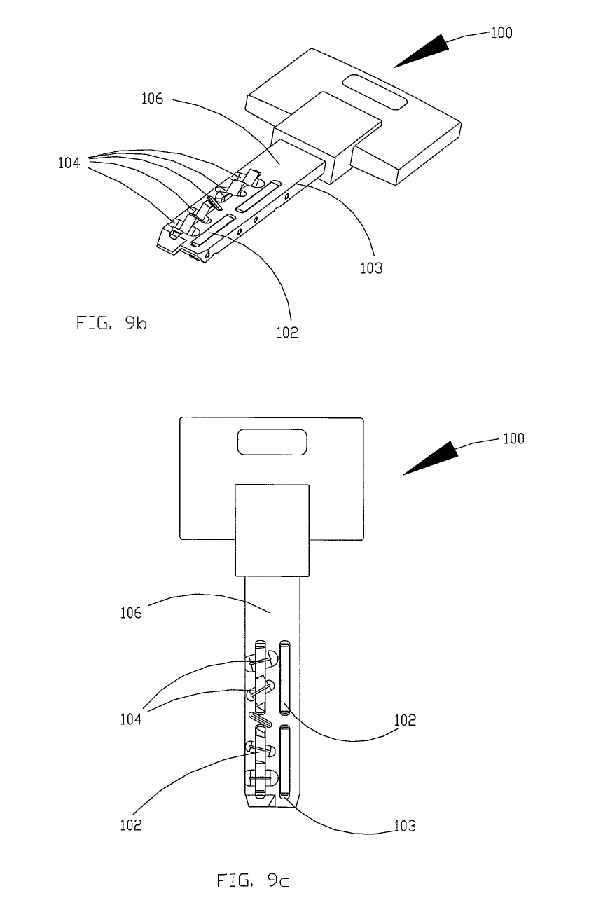

According to another embodiment of the invention, inserts 87 include two pin-engaging recesses 86, one at each end thereof, which allow the entire insert to move inward into shank 82. According to yet another embodiment, the inserts pivot about a central pin 88. The appropriate depressions in the blank that make each key unique and complementary to a specific lock can be created, as known, in shank-82 by cutting through inserts 87 and into the shank's surface, as shown in FIG. 9a below. It will be appreciated by those skilled in the art that the key of this embodiment can be utilized with any conventional cylinder lock, by modifying the plug which receives the key.

According to an alternative embodiment of the invention, the cylinder lock illustrated in FIG. 1 may be designed to utilize a key having at least one insert, as described above. A plug 90 for such a cylinder lock is illustrated in FIG. 9a, and a complementary key 100 is illustrated in FIG. 9b. In this embodiment, plug 90 includes a keyway 92 with two elongated grooves 94 for receiving inserts 102 protruding from key 100. Inserts 102 may be press fit into bores 103 in shank 106, or may be mounted for reciprocating or pivotal movement, as about a plurality of pins 110. Key 100 includes depressions 104 carved on shank 106 through inserts 102. Inserts 102 slide through grooves 94, and depressions 104 engage the angled tips of the radially displaceable tumbler pins in the lock casing.

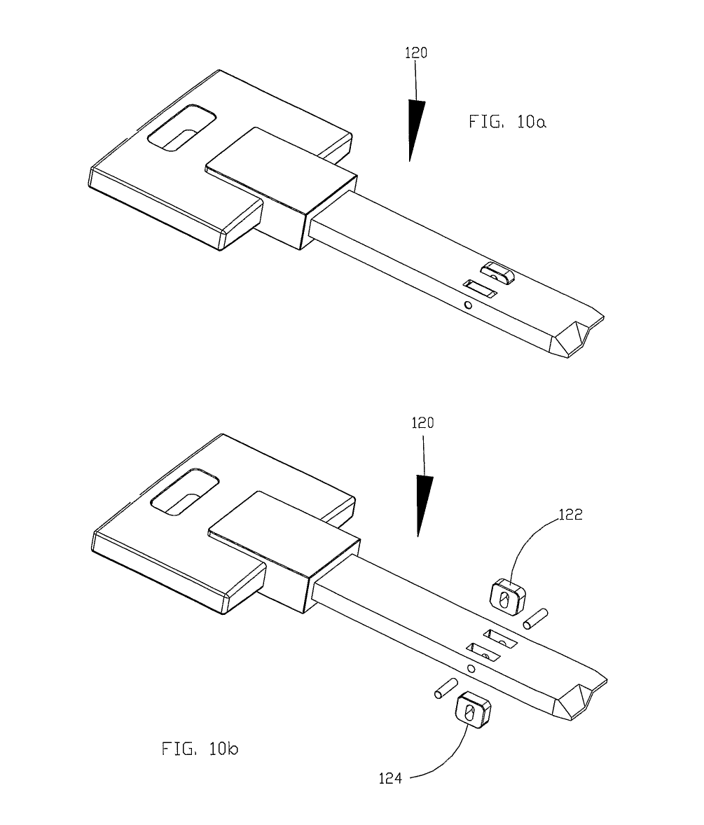

With reference to FIGS. 10a and 10b, there is shown a key 120 constructed and operative in accordance with an alternative embodiment of the invention. In this embodiment, only one insert 122, 124 is provided on each side of the key.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. A pin tumbler cylinder lock having a cylinder casing and a plug selectively rotatable in the casing, and a plurality of driver pins and associated tumbler pins rotatable about their longitudinal axes, the lock comprising:
a plurality of parallel circumferential tracks formed in said cylinder casing;
and wherein
each of said tumbler pins is adapted and configured to seat in said plug and includes a track engaging element arranged to selectively engage one of said tracks.

2. The cylinder lock according to claim 1, wherein
said tracks are circumferential channels formed in internal surface of cylinder casing; and
said tumbler pins have a ridge adapted and configured to move in said channels when said plug is rotated in said casing.

3. The cylinder lock according to claim 1, wherein
said tracks are circumferential ridges formed in an internal surface of said cylinder casing; and
said tumbler pins have a groove adapted and configured to engage said ridges when said plug is rotated in said casing.

4. The cylinder lock according to claim 1, wherein said driver pins and said tumbler pins have mating surfaces for engaging one another, whereby each driver pin selectively engages an associated tumbler pin.

5. The cylinder lock according to claim 1,
having an associated symmetrical key having a plurality of depressions in both side surfaces;
and wherein each of said tumbler pins has a tapered tip for engaging and being rotated by said depressions on said key.

6. A key for a pin tumbler cylinder lock having a plurality of tumbler pins, said key comprising:
a shank having a plurality of depressions in two opposing side surfaces, said depressions being formed at an angle to one another;
said depressions being adapted and configured, when inserted into the cylinder lock, to engage said tumbler pins and rotate said tumbler pins about their longitudinal axes.

7. The key according to claim 6, wherein said depressions are ground by a pointed bit grinding a linear depression.

8. A method for forming a pin tumbler cylinder lock having a cylinder casing and a plug selectively rotatable in the casing, and a plurality of driver pins and associated tumbler pins rotatable about their longitudinal axes, the method comprising:
forming a plurality of parallel circumferential tracks in a cylinder casing of a cylinder lock; and
providing a plurality of tumbler pins, each including a track engaging element; and
disposing said tumbler pins in said plug whereby each of said track engaging elements selectively engages one of said tracks.

9. A method for making a key for a pin tumbler cylinder lock having a plurality of tumbler pins, said method comprising:
forming a plurality of depressions in two opposing side surfaces of a key shank, said depressions being formed at an angle to one another;
said depressions being adapted and configured, when inserted into the cylinder lock, to engage said tumbler pins and rotate said tumbler pins about their longitudinal axes.

10. The cylinder lock according to claim 1, wherein said plug defines at least one rail groove for receiving at least one insert protruding from a complementary key.

11. A key for a cylinder lock according to claim 6, said key further comprising:
said shank defining at least one shank bore; and
at least one insert protruding from said shank, said insert being disposed in said bore.

12. The key according to claim 11, wherein said inserts are movably disposed in said bore.

13. The key according to claim 10, wherein a plurality of depressions are cut on said shank and said inserts are complementary to pin tumblers in a complementary lock;
said depressions being adapted and configured, when inserted into the cylinder lock, to engage said tumbler pins so as to open said lock.

14. The key according to claim 11, wherein said plurality of depressions are cut on said shank and said inserts are complementary to pin tumblers in a complementary lock;
said depressions being adapted and configured, when inserted into the cylinder lock, to engage said tumbler pins so as to open said lock.
